(19) United States
(12) Patent Application Publication
(10) Pub. No.: US 2007/0062456 A1
(43) Pub. Date: Mar. 22, 2007

(54) Animal bed

(76) Inventor: Laura Pace, Conroe, TX (US)

Correspondence Address: D'AMBROSIO & ASSOCIATES, P.L.L.C., 10260 WESTHEIMER, SUITE 465, HOUSTON, TX, 77042, US

(21) Appl. No.: 11/228,704

(22) Filed: Sep. 16, 2005

(51) Int. Cl. A01K 29/00

(52) U.S. Cl. 119/28.5

(57) ABSTRACT

An animal bed comprising a bottom sheet and a plurality of top sheets. The bottom sheet and top sheets defining openings and crawl spaces accessible via the openings.

### BACKGROUND OF THE INVENTION

1. Technical Field

The present invention relates to animal beds in general and in particular to animal beds suited to allow an animal to burrow.

2. Description of Related Art

Certain animals have a tendency to sleep in burrows, holes or caves. Burrowing animals are often kept as pets by humans. Dogs, cats, ferrets, and hamsters are examples of pets that tend to burrow. Consequently, there is a need for animal beds which allow animals to burrow into a cozy spot to sleep.

There are many types of animal beds that are available in the marketplace. These beds range from basic pillows to elaborate domed beds. Some of these beds are covered to simulate an animal burrow. This includes sleeping bag type beds, where the two pieces of fabric are stitched together on three sides. The majority of covered animal beds have semi-rigid coverings that do not provide the cozy environment craved by burrowing animals. Consequently, it would be desirable to provide an improved animal bed that allows the animal to arrange the bed to its liking.

### SUMMARY OF THE INVENTION

The animal bed of the present invention provides multiple layers of coverings so that an animal can crawl between the coverings and arrange them into a cozy burrow.

In accordance with a preferred embodiment of the invention, the animal bed comprises a bottom sheet, a conformable inner sheet, and an outer sheet. The bottom sheet comprises a perimeter. The perimeter can have at least four segments, a first perimeter segment, a second perimeter segment, a third perimeter segment, and a fourth perimeter segment.

The inner sheet comprises a first inner sheet end and a second inner sheet end. The second inner sheet end is preferably opposite to the first inner sheet end. The first inner sheet end can attach to the first perimeter segment and the second inner sheet end can attach to the second perimeter segment.

The outer sheet comprises a first outer sheet end and a second outer sheet end. The second outer sheet end is preferably opposite the first outer sheet end. The first outer sheet end can attach to the third perimeter segment and the second outer sheet end can attach to the fourth perimeter segment. The outer sheet can be attached at an angle to the inner sheet and can overlay the inner sheet. The inner sheet and the outer sheet define at least one opening.

In another preferred embodiment of the invention animal bed comprises a bottom sheet, an inner sheet, and a outer sheet. The bottom sheet comprises a perimeter. The perimeter comprises at least four segments, a first perimeter segment, a second perimeter segment opposite the first perimeter segment, a third perimeter segment, and a fourth perimeter segment opposite the third perimeter segment.

The inner sheet can be conformable to the animal. The inner sheet comprises a first inner sheet end, a second inner sheet end, a first inner sheet unattached edge, and a second inner sheet unattached edge. The second inner sheet end is preferably opposite to the first inner sheet end. The first inner sheet unattached edge is preferably opposite to the second inner sheet unattached edge. The first inner sheet end is preferably attached to the first perimeter segment. The second inner sheet end is attached to the second perimeter segment.

The outer sheet can also be conformable to the animal. The outer sheet comprises a first outer sheet end, a second outer sheet end, a first outer sheet unattached edge, and a second outer sheet unattached edge. The second outer sheet end is preferably opposite to the first outer sheet end. The first outer sheet unattached edge is preferably opposite to the second outer sheet unattached edge. The first outer sheet end is preferably attached to the third perimeter segment. The second outer sheet end is attached to the fourth perimeter segment.

The outer sheet can be attached to the bottom sheet at a substantially right angle to the inner sheet. The outer sheet overlays the inner sheet. The first outer sheet unattached edge and the first inner sheet unattached edge define a first opening. The first outer sheet unattached edge and the second inner sheet unattached edge define a second opening. The second outer sheet unattached edge and the first inner sheet unattached edge define a third opening. The second outer sheet unattached edge and the second inner sheet unattached edge define a fourth opening. The first outer sheet unattached edge and the inner sheet define a fifth opening. The second outer sheet unattached edge and the inner sheet define a sixth opening.

The inner sheet and the bottom sheet define a first crawl space accessible by the first, second, third, and fourth openings. The outer sheet and inner sheet define a second crawl space accessible by the first, second, third, and fourth openings. Preferably, the inner sheet and the outer sheet comprise a cloth-like flexible fabric to conform to the animal when it is in the crawl space.

In yet another preferred embodiment of the invention, the animal bed comprises a bottom sheet and a plurality of top sheets. The bottom sheet has a perimeter. Each top sheet has a first end and a second end. Preferably, the first end of the top sheet is positioned opposite to the second end of each top sheet. The top sheets are attached to the perimeter of the bottom sheet by the first ends and the second ends of the top sheet. Each top sheet can be attached to the bottom sheet at an angle to other top sheets, so that the top sheets overlay each other. A first crawl space can be defined between the bottom sheet and the top sheet. One or more additional crawl spaces can be defined between the plurality of top sheets. The angled overlay causes the top sheets and bottom sheet to define a plurality of openings to the crawl spaces between the sheets.

### BRIEF DESCRIPTION OF THE DRAWINGS

FIG. 1 is a top view of an animal bed, in accordance with one preferred embodiment of the invention.

FIG. 2 is a top view of an animal bed, in accordance with a second preferred embodiment of the invention.

### DEFINITIONS

For the purposes of this invention, “conformable” is defined as: capable of adjusting shape.

For the purposes of this invention, “gathered” is defined as: drawn into small folds or puckers.

For the purposes of this invention, “a burrow” is defined as: a narrow or snug place.

For the purposes of this invention, “darted” is defined as having tapered tucks sewn in.

### DETAILED DESCRIPTION

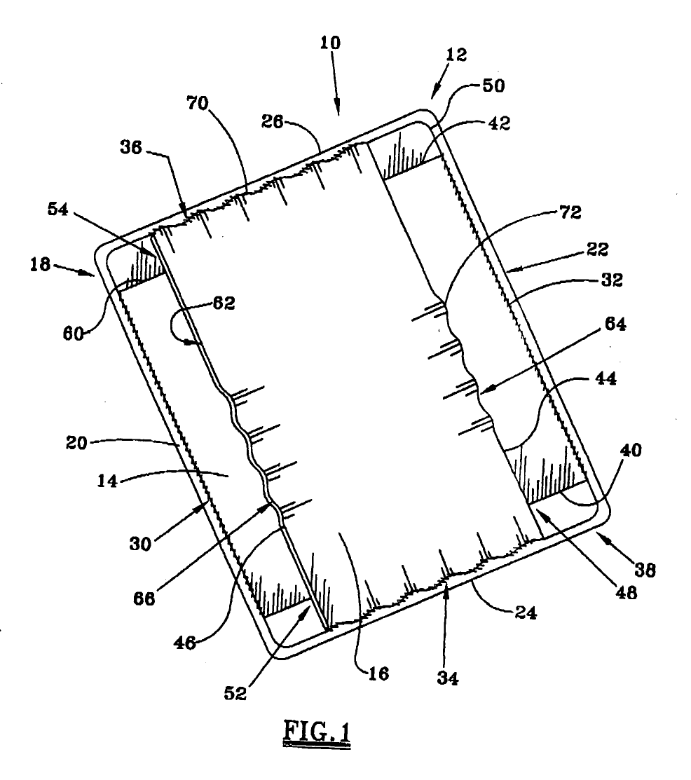

Referring now to the drawings and in particular to FIG. 1, a top view of an animal bed is illustrated in accordance with one preferred embodiment of the invention. As shown, an animal bed 10 includes a bottom sheet 12, an inner sheet 14, and an outer sheet 16. Preferably, the bottom sheet 12, inner sheet 14, and outer sheet 16 are substantially rectangular. The bottom sheet 12 has a perimeter 18. The perimeter is the region of the bottom sheet that generally borders the boundaries of the bottom sheet. The perimeter 18 comprises several segments, namely a first perimeter segment 20, a second perimeter segment 22, a third perimeter segment 24, and a fourth perimeter segment 26. To provide comfort for the animal, the bottom sheet 12 can comprise a pillow, a pad, a cushion, a blanket, a pillow case, or combination thereof. The two or more fabric sheets 14, 16 are attached to the bottom sheet 12 in a manner that defines one or more crawl spaces so that the animal can borrow into the crawl spaces. The sheets are attached so that multiple openings are created, allowing access to the crawl spaces.

In one embodiment, the inner sheet 14 is provided with a first inner sheet end 30 and a second inner sheet end 32 opposite to the first inner sheet end 30. Preferably, the first inner sheet end 30 is parallel to the second inner sheet end 32. The first inner sheet end 30 is attached to the first perimeter segment 20. The second inner sheet end 32 is attached to the second perimeter segment 22. The inner sheet 14 is preferably conformable to the animal and drapes around the animal so that the animal can arrange the bed into a cozy burrow.

The outer sheet 16 is provided with a first outer sheet end 34 and a second outer sheet end 36 opposite the first outer sheet end 34. The first outer sheet end 34 is attached to the third perimeter segment 24. The second outer sheet end 36 is attached to the fourth perimeter segment 26. The outer sheet can also be conformable to allow the animal to arrange the bed to burrow in and arrange the bed to its liking. Preferably, both the inner sheet 14 and the outer sheet 16 are longer than the length and the width of the bottom sheet 12 to provide the animal extra fabric 72 in which to form a burrow.

The outer sheet 16 is attached at an angle to the inner sheet 14, and overlays the inner sheet 14. Preferably, the outer sheet 16 is attached to the bottom sheet 12 at a right angle to the inner sheet 14. As overlaid, the inner sheet 14 and outer sheet 16 define at least one, and preferably multiple openings 38, 50, 52, 54. The openings 38, 50, 52, 54 allow an animal to pass into the crawl spaces between the sheets 60, 62. The overlapping arrangement of the conformable inner sheet 14 and outer sheet 16 allow the animal to remain covered by the outer sheet 16 and arrange the inner sheet 14 into a comfortable nest while resting on either directly on the bottom sheet 12 or the inner sheet 14.

An attachment means attaches the inner sheet ends 30, 32 and outer sheet ends 34, 36 to the perimeter of the bottom sheet. The inner sheet 14 and outer sheet 16 are optionally detachable from the bottom sheet 12. The attachments means is suitably one or a combination of stitches, zippers, snaps, buttons, rivets, Velcro, and an adhesive substance.

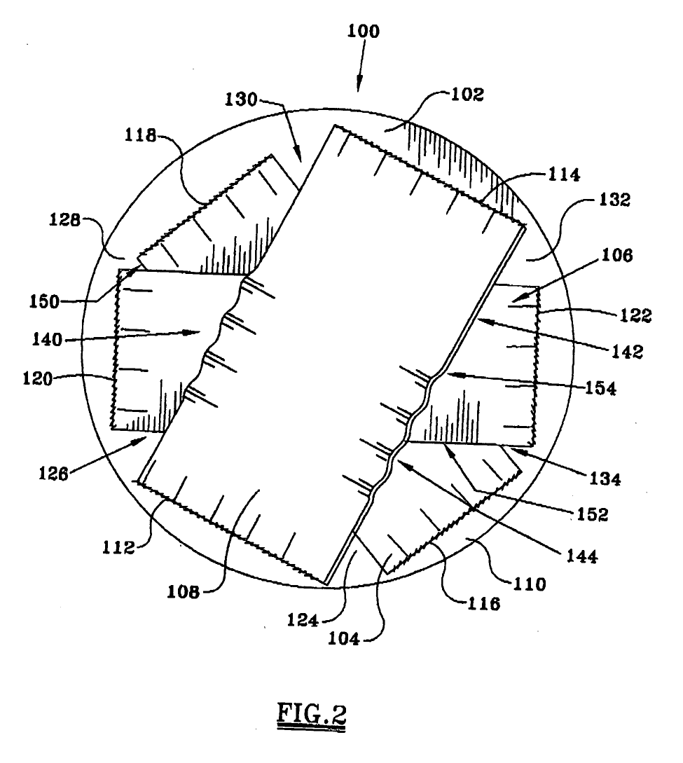

To increase the utility of the bed, the animal bed can be sized to fit within an animal cage or a bed frame. In one aspect, the inner sheet 14 and outer sheet 16 can comprise a fabric material, a plastic material, or a combination thereof. The fabric material is preferably selected from denim, cotton, canvas, man-made fabric, fleece, and combinations thereof. These fabrics are preferably soft and flexible so that they easily conform to the animal. The inner sheet ends 30, 32 and outer sheet ends 34, 36 are can be gathered ends 70. The gathered ends 70 provide additional loose material for the animal to nest with. The inner sheet ends 30, 32 and outer sheet ends 34, 36 may also be darted ends, as shown in 160 of FIG. 2. The darted ends 160 also provide loose material for the animal to nest with.

The lengths of the inner sheet 14 and outer sheet 16 can be greater than the distance between the attachments of the inner sheet ends 30, 32 and the distance between the outer sheet ends 34, 36. The excess length provides the animal with excess fabric 72 which the animal can adjust to form a cozy burrow.

Two crawl spaces 60, 62 are preferably defined by the bottom sheet 12, the inner sheet 14 and the outer sheet 16. The first crawl space 60 is the area defined between the inner sheet and the bottom sheet. The second crawl space 62 is the area defined between the outer sheet 16 and the inner sheet 14. The animal can access the two crawl spaces 60, 62 through the one or more openings 38, 50, 52, 54.

In another preferred embodiment of the invention, the inner sheet 14 has a first inner sheet unattached edge 40 and a second inner sheet unattached edge 42. The second inner sheet unattached edge 42 is opposite the first inner sheet unattached edge 40. The outer sheet 16 has a first outer sheet unattached edge 44 and a second outer sheet unattached edge 46. The second outer sheet unattached edge 46 is opposite the first inner sheet unattached edge 44. As the inner sheet and outer sheet cross over each other, the unattached edges form multiple openings to the crawl spaces 60, 62 between the sheets. The first outer sheet unattached edge 44 and the first inner sheet unattached edge 40 define a first opening 48. The first outer sheet unattached edge 44 and the second inner sheet unattached edge 42 define a second opening 50. The second outer sheet unattached edge 46 and the first inner sheet unattached edge 40 define a third opening 52. The second outer sheet unattached edge 46 and the second inner sheet unattached edge 42 define a fourth opening 54. The first outer sheet unattached edge 44 and the inner sheet 14 define a fifth opening 64. The second outer sheet unattached edge 46 and the inner sheet 14 define a sixth opening 66.

Referring now to FIG. 2 in accordance with still another preferred embodiment of the invention, the animal bed 100 includes a bottom sheet 102 and a plurality of top sheets 104, 106, 108. A plurality of crawl spaces 150, 152, 154 are created between the sheets 102, 104, 106, 108. Preferably, the bottom sheet 10 comprises a pillow, pad, blanket, fabric section, plastic section, or a combination thereof. The top sheets 104, 106, 108 can comprise a pillow, pad, blanket, fabric section, plastic section, or a combination thereof. The top sheets 104, 106, 108 are preferably flexible to conform to the shape of the animal once the animal has crawled between the sheets 102, 104, 106, 108.

The bottom sheet 102 has a perimeter 110 to which the top sheets 104, 106, 108 are attached. Each top sheet 104 has a first end 112, 116, 120 and a second end 114, 118, 122. The first ends 112, 116, 120 are positioned opposite the second end 114, 118, 122. Preferably, the first ends 112, 116, 120 and second ends 114, 118, 122 are gathered ends, as shown in 70 of FIG. 1. Alternatively, the first top sheet ends 112, 116, 120 and second top sheet ends 114, 118, 122 may also be darted ends 160. The gathering or darting of the ends allows wider sheets to be used, providing additional fabric for the animal to nest in.

The top sheets 104, 106, 108 are attached to the perimeter 110 at the first end 112, 116, 120 and the second end 114, 118, 122 by a means for attachment. The means for attachment is suitably stitches, zippers, snaps, buttons, rivets, Velcro, an adhesive substance, and combinations thereof. Each top sheet is attached at an angle to other top sheets, so that the top sheets overlay each other. The top sheets and bottom sheet define a plurality of openings 124, 126, 128, 130, 132, 134, 140, 142, 144. Preferably, the lengths of top sheets 104, 106, 108 are greater than the distance between the attachments of the first ends 112, 116, 120 and the second ends 114, 118, 122. The greater length also provides the animal with excess fabric, as shown in 72 of FIG. 1, to nest into and form its burrow.

Preferably, the bottom sheet 102 and a first top sheet 104 define a first crawl space 150, accessible through the plurality of openings 124, 126, 128, 130, 132, 134, 140, 142, 144, and the plurality of top sheets define a plurality of additional crawl spaces 152, 154 accessible by the plurality of openings 124, 126, 128, 130, 132, 134, 140, 142, 144.

As has been described, the present invention provides an improved animal bed that allows animals to nest and burrow. While the invention has been described with reference to preferred embodiments, it will be understood by those skilled in the art that various changes in form and detail may be made therein without departing from the spirit and scope of the invention.

1. An animal bed comprising:
a bottom sheet comprising a perimeter,
the perimeter comprising a first perimeter segment, a second perimeter segment, a third perimeter segment, and a fourth perimeter segment;
a conformable inner sheet comprising a first inner sheet end and a second inner sheet,
the second inner sheet end opposite to the first inner sheet end, the first inner sheet end attached to the first perimeter segment and the second inner sheet end attached to the second perimeter segment;
an outer sheet comprising a first outer sheet end and a second outer sheet end,
the second outer sheet end opposite the first outer sheet end, the first outer sheet end attached to the third perimeter segment and the second outer sheet end attached to the fourth perimeter segment;
the outer sheet attached at an angle to the inner sheet, the outer sheet overlaying the inner sheet, the inner sheet and the outer sheet defining at least one opening;
the inner sheet and the bottom sheet defining a first crawl space accessible by at least one opening; and
the outer sheet and inner sheet defining a second crawl space accessible by at least one opening.

2. The animal bed of claim 1 wherein the first inner sheet end is parallel to the second inner sheet end and the first outer sheet end is parallel to the second outer sheet end.

3. The animal bed of claim 1 wherein the first inner sheet end, second inner sheet end, first outer sheet end, and second outer sheet end are gathered ends.

4. The animal bed of claim 1 wherein the he first inner sheet end, second inner sheet end, first outer sheet end, and second outer sheet end are darted ends.

5. The animal bed of claim 1 wherein the bottom sheet is selected from a pillow, a cushion, a pad, a blanket, a pillow case, and combinations thereof.

6. The animal bed of claim 1 wherein the inner sheet and the outer sheet comprise a fabric material, a plastic material, or combinations thereof.

7. The animal bed of claim 6 wherein the bottom sheet is selected from a pillow, a cover for a pillow, a cushion, a pad, a blanket, and combinations thereof.

8. The animal bed of claim 6 wherein the fabric material is selected from denim, cotton, canvas, man-made fabrics, fleece, and combinations thereof.

9. The animal bed of claim 1 further comprising one or more attachment means for attaching the first end and second end of the inner sheet and the first end and second end of the outer sheet to the bottom sheet.

10. The animal bed of claim 9 wherein the attachment means is selected from stitches, zippers, snaps, buttons, rivets, Velcro, an adhesive substance, and combinations thereof.

11. The animal bed of claim 1 wherein the bed is sized to fit within an animal cage.

12. The animal bed of claim 1 wherein the animal bed is sized to fit within a bed frame.

13. The animal bed of claim 1 wherein:
the length of the inner sheet is greater than the distance between the attachments of the first inner sheet end and second inner sheet end to the bottom sheet perimeter; and
the length of the outer sheet is greater than the distance between the attachments of the first outer sheet end and second outer sheet end to the bottom sheet perimeter.

14. The animal bed of claim 1 wherein the bottom sheet, inner sheet and outer sheet are substantially rectangular shaped.

15. The animal bed of claim 1 wherein inner sheet further comprises two unattached inner sheet edges and the outer sheet further comprises two outer sheet unattached edges, the two inner sheet unattached edges and the two outer sheet unattached edges defining the one or more openings.

16. The animal bed of claim 1 wherein:
the inner sheet further comprises a first inner sheet unattached edge and a second inner sheet unattached edge, the second inner sheet unattached edge opposite the first inner sheet unattached edge;
the outer sheet further comprises a first outer sheet unattached edge and a second outer sheet unattached edge,
the second outer sheet unattached edge opposite the first inner sheet unattached edge; and
the first outer sheet unattached edge and the first inner sheet unattached edge define a first opening,
the first outer sheet unattached edge and the second inner sheet unattached edge define a second opening,
the second outer sheet unattached edge and the first inner sheet unattached edge define a third opening, and
the second outer sheet unattached edge and the second inner sheet unattached edge define a fourth opening.

17. An animal bed comprising:
a bottom sheet comprising a perimeter,
the perimeter comprising a first perimeter segment, a second perimeter segment opposite the first perimeter segment, a third perimeter segment, and a fourth perimeter segment opposite the third perimeter segment;
a conformable inner sheet comprising a first inner sheet end, a second inner sheet end, a first inner sheet unattached edge, and a second inner sheet unattached edge,
the second inner sheet end opposite to the first inner sheet end,
the second inner sheet unattached edge opposite the first inner sheet unattached edge,
the first inner sheet end attached to the first perimeter segment and the second inner sheet end attached to the second perimeter segment;
a conformable outer sheet comprising a first outer sheet end, a second outer sheet end, a first outer sheet unattached edge, and a second outer sheet unattached edge,
the second outer sheet end opposite the first outer sheet end,
the second outer sheet unattached edge opposite the first inner sheet unattached edge,
the first outer sheet end attached to the third perimeter segment and the second outer sheet end attached to the fourth perimeter segment;
the outer sheet attached to the inner sheet at a substantially right angle,
the outer sheet overlaying the inner sheet,
the first outer sheet unattached edge and the first inner sheet unattached edge defining a first opening,
the first outer sheet unattached edge and the second inner sheet unattached edge defining a second opening,
the second outer sheet unattached edge and the first inner sheet unattached edge defining a third opening,
the second outer sheet unattached edge and the second inner sheet unattached edge defining a fourth opening,
the first outer sheet unattached edge and the inner sheet defining a fifth opening,
the second outer sheet unattached edge and the inner sheet defining a sixth opening;
the inner sheet and the bottom sheet defining a first crawl space accessible by the first, second, third, and fourth openings; and
the outer sheet and inner sheet defining a second crawl space accessible by the fifth and sixth openings.

18. The animal bed of claim 17 wherein the bottom sheet is selected from a pillow covering, a pillow, a cushion, a pad, a blanket, and combinations thereof.

19. The animal bed of claim 17 wherein inner sheet and outer sheet comprise a fabric selected from a group consisting essentially of denim cotton, canvas, man-made fabrics, fleece, and combinations thereof.

20. An animal bed comprising:
a bottom sheet comprising a perimeter;
a plurality of conformable top sheets,
each top sheet comprising a first end and a second end,
the first end of each top sheet positioned opposite the second end of each top sheet,
each top sheet attached to the perimeter of the bottom sheet at the first end and the second end by a means for attachment,
each top sheet attached at an angle to the other top sheets, so that the top sheets overlay each other, the top sheets defining a plurality of openings;
the bottom sheet and a first top sheet defining a first crawl space accessible by the plurality of openings; and
the plurality of top sheets defining a plurality of additional crawl spaces accessible by the plurality of openings.

21. The animal bed of claim 20 wherein the bottom sheet and top sheets comprise a pillow, a cushion, a pad, a blanket, a fabric section, a plastic section, or combinations thereof.

22. The animal bed of claim 20 wherein the first ends and the second ends are gathered ends.

23. The animal bed of claim 20 wherein the first ends and the second ends are darted ends.

24. The animal bed of claim 20 wherein the means for attachment is selected from a group consisting of stitches, zippers, snaps, buttons, rivets, Velcro, an adhesive substance, and combinations thereof.

25. The animal bed of claim 20 wherein the length of each top sheet is the distance between the top sheet ends and the length of the top sheet is greater than the distance between the attachments of the first ends and the second ends.
